(19) United States
(12) Patent Application Publication
(10) Pub. No.: US 2016/0285304 A1
(43) Pub. Date: Sep. 29, 2016

(54) Portable Solar Power Generator

(71) Applicant: William Stiefel, Mullica Hill, NJ (US)

(72) Inventor: William Stiefel, Mullica Hill, NJ (US)

(21) Appl. No.: 15/071,555

(22) Filed: Mar. 16, 2016

Related U.S. Application Data
(60) Provisional application No. 62/139,390, filed on Mar. 27, 2015.

(51) Int. Cl. H02J 7/35; H02S 40/38; H02S 40/32; H02J 7/00; H02S 10/40

(52) U.S. Cl. CPC H02J 7/355; H02J 7/007; H02S 10/40; H02S 40/32; H02S 40/38

(57) ABSTRACT

A portable solar power generator for powering various electronic devices. The portable solar power generator includes one or more solar panels pivotally connected to a housing such that the panels can be pivoted into a desired position for maximizing collection of solar energy. The solar panels are electrically connected to a solar charge controller, wherein the solar charge controller is connected to one or more rechargeable batteries adapted to store electricity produced by the solar panels. The housing includes a base, sidewalls, and an open upper end, defining an interior volume. The housing stores the battery and solar charge controller therein and protects the same from environmental conditions. The housing includes a power outlet thereon that distributes electricity stored in the batteries to any of various electronic devices. The housing preferably comprises a wheeled base for allowing the solar power generator to be easily transported.

### CROSS REFERENCE TO RELATED APPLICATION

This application claims the benefit of U.S. Provisional Application No. 62/139,390 filed on Mar. 27, 2015. The above identified patent application is herein incorporated by reference in its entirety to provide continuity of disclosure.

### BACKGROUND OF THE INVENTION

### Field of the Invention

The present invention relates to solar power generators. More specifically, the present invention provides a portable solar power generator adapted for use in powering any of various electronic devices, appliances, and equipment when the user is not connected to an electrical power grid.

It is often desirable to have access to electricity while unconnected to a power grid, such as when the person is traveling, camping, or the like. Electricity is required to power any of various devices including electronic devices, water pumps, and heating units, among others. When a person does not have access to an electrical power grid, the user must instead utilize a generator, such as a gas generator, in order to produce electricity. These generators can be extremely difficult to transport, create pollution, and are very loud. Further, the generator may quickly run out of fuel, preventing the user from further utilizing the generator. As a result, such generators can be an inconvenient and cumbersome solution to the problem of providing electricity to a user in a remote location.

As a result, many people have turned to utilizing renewable energy sources to generate electricity in order to eliminate the need for fuel input and to reduce waste and pollution. However, many sources of renewable energy, such as solar energy, are not adapted for use by individuals to generate power. Further, conventional solar generators can be bulky and are not easily transported. Such generators are instead configured to be installed in a fixed location, such as on the roof of a building.

Devices have been disclosed in the prior art that relate to solar panel support devices. These include devices that have been patented and published in patent application publications. These devices generally relate to portable solar cells for supporting and pivoting a solar panel, such as U.S. Pat. No. 6,201,181, U.S. Pat. No. 7,492,120, U.S. Pat. No. 8,193,760, U.S. Published Patent Application Number 2004/211457, U.S. Published Patent Application Number 2009/0288698, U.S. Published Patent Application Number 2010/0109601, U.S. Published Patent Application Number 2012/0025750, and WO2011/3036609.

These prior art devices have several known drawbacks. Several devices in the prior art simply relate to frames or supports for supporting a solar panel in a desired position for collecting solar energy. Such devices are not adapted to then distribute the electricity for use by a user. Further, many devices in the prior art fail to include an enclosed housing in which the electrical components are stored.

In light of the devices disclosed in the prior art, it is submitted that the present invention substantially diverges in design elements from the prior art and consequently it is clear that there is a need in the art for an improvement to existing portable solar power generators. In this regard the instant invention substantially fulfills these needs.

### SUMMARY OF THE INVENTION

In view of the foregoing disadvantages inherent in the known types of solar power generator devices now present in the prior art, the present invention provides a new solar power generator wherein the same can be utilized for providing convenience for the user when generating electricity for powering any of various devices when the user does not have access to the power grid.

It is therefore an object of the present invention to provide a new and improved portable solar power generator comprising a housing on which a solar panel is removably and pivotally mounted.

It is another object of the present invention to provide a portable solar power generator adapted to generate electricity, store the generated electricity, and distribute the electricity to electronic devices and appliances.

Another object of the present invention is to provide a portable solar power generator that is easily transported and assembled for use.

Yet another object of the present invention is to provide a portable solar power generator having an adjustably positioned solar panel that allows the user to adjust the angle of the solar panel throughout the day.

Another object of the present invention is to provide a solar power generator that can accommodate a plurality of solar panels and batteries so as to allow the user to scale production of electricity.

An additional object of the present invention is to provide a solar power generator that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable solar power generator.

FIG. 2 shows a side cross sectional view of the portable solar power generator.

FIG. 3 shows a flowchart of the operation of the portable solar power generator.

### DETAILED DESCRIPTION OF THE INVENTION

Reference is made herein to the attached drawings. Like reference numerals are used throughout the drawings to depict like or similar elements of the solar power generator device. For the purposes of presenting a brief and clear description of the present invention, the preferred embodiment will be discussed as used for generating electricity in order to allow the user to power any of various appliances and electrical devices. The figures are intended for representative purposes only and should not be considered to be limiting in any respect.

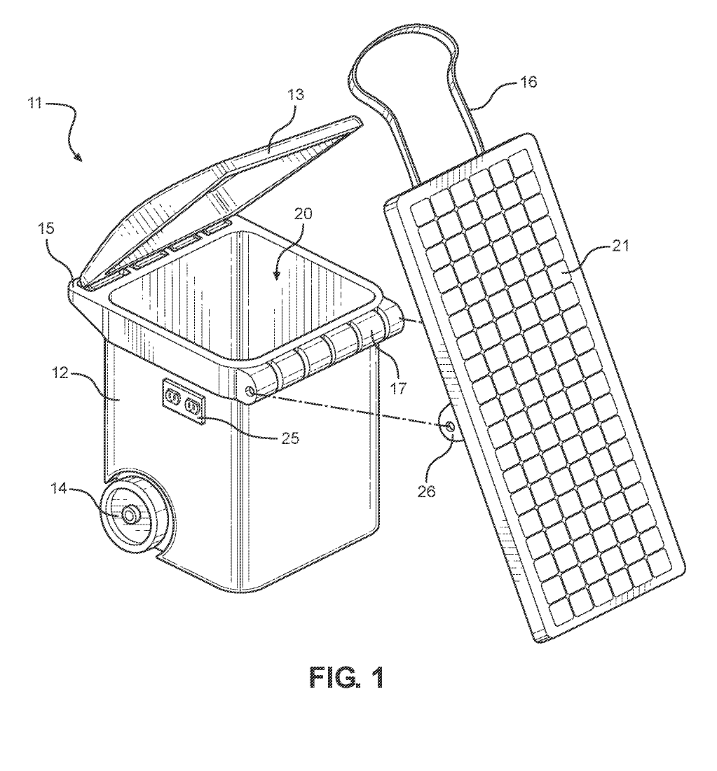

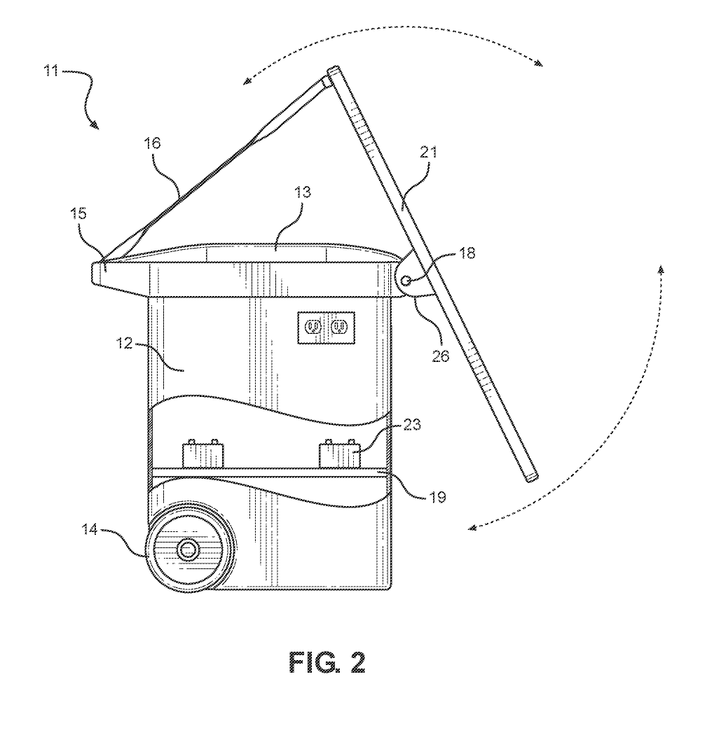

Referring now to FIGS. 1 and 2, there is shown a perspective view and a side cross sectional view of the portable solar power generator, respectively. The portable solar power generator 11 comprises a housing 12 having a base, sidewalls, and an open upper end, defining an interior volume 20. The open upper end is removably covered via a lid 13, wherein the lid 13 is adapted to fully cover the open upper end of the housing 12 so as to enclose the interior volume 20. The lid 13 is pivotally or removably attached to the upper end, depending upon the embodiment. The lid 13 allows the user to access the interior volume 20 of the housing 12 in which several components of the portable solar power generator 11 are positioned. The housing 12 is preferably composed of a waterproof material so as to prevent liquid from penetrating the housing 12. Further, the housing 12 is preferably composed of a rigid and lightweight material, such as a hard plastic, so as to protect components stored therein and so as to be capable of supporting one or more solar panels 21 thereon.

The housing 12 preferably includes one or more pairs of wheels 14 thereon so as to allow the housing 12 to be easily rolled from one location to another. Preferably, the wheels 14 are mounted on the base of the housing 12 so as to engage the ground when the housing 12 is positioned in an upright, resting orientation. In the illustrated embodiment, the housing 12 includes a single pair of wheels 14 disposed on a rear portion of the housing 12, wherein the wheels 14 can be utilized to move the housing 12 when the housing 12 is tilted so that only the wheels 14 engage the ground. When the housing 12 is not desired to be moved, the housing 12 can be positioned in an upright orientation wherein the housing 12 will not roll or otherwise move as the base is in contact with the ground. The housing 12 includes a handle 15 on a rear portion thereof so as to allow the user to more easily tilt the housing 12 and control the movement thereof.

One or more solar panels 21 are provided, wherein at least one solar panel 21 is removably securable to the upper end of the housing 12. Each solar panel 21 preferably includes a mounting fastener 26 on a rear surface thereof that is adapted to engage with a mating fastener 17 disposed on the upper end of the housing 12. Preferably, the mounting fastener 26 and mating fastener 17 create a pivoting connection between the solar panel 21 and the housing 12 such that the angle of the solar panel 21 can be adjusted in order to track the movement of the sun throughout the day. This allows the user to adjust the angle of the solar panel 21 relative to a horizontal plane so as to increase the efficiency thereof. In some embodiments, the mating fastener 17 and mounting fastener 26 comprise interlocking hinge sections connected by a pin 18 that is inserted through the interlocking hinge sections so as to pivotally secure the solar panel 21 to the housing 12.

The solar panel 21 further includes one or more securement straps 16 thereon. The securement straps 16 extend from the periphery of the solar panel 21 and can be adjustably tied to or wrapped around a portion of the housing 12, such as the handle 15 thereof. Once the solar panel 21 has been pivoted into a desired position for collecting solar energy, the straps 16 can be affixed to the housing 12 so as to secure the solar panel 21 in the desired configuration. This allows a user to easily adjust the angle of the solar panel 21 by adjusting the securement straps 16.

The interior volume 20 of the housing 12 encloses the electrical components of the solar power generator so as to protect the components and prevent them from being damaged. The housing 12 encloses a solar charge controller and one or more rechargeable batteries 23 therein for storing the electricity produced by the solar panels 21. Further, a solar inverter is enclosed within the housing 12.

The batteries 23 are preferably positioned on a shelf 19 within the housing 12. The shelf 19 serves to elevate the batteries 23 and other components above ground level and above the base of the housing 12. While the housing 12 is constructed so as to be waterproof in order to protect the components therein, the shelf 19 helps to further ensure that the electrical components are not wet in the event that water enters or collects within the lower end of the housing 12.

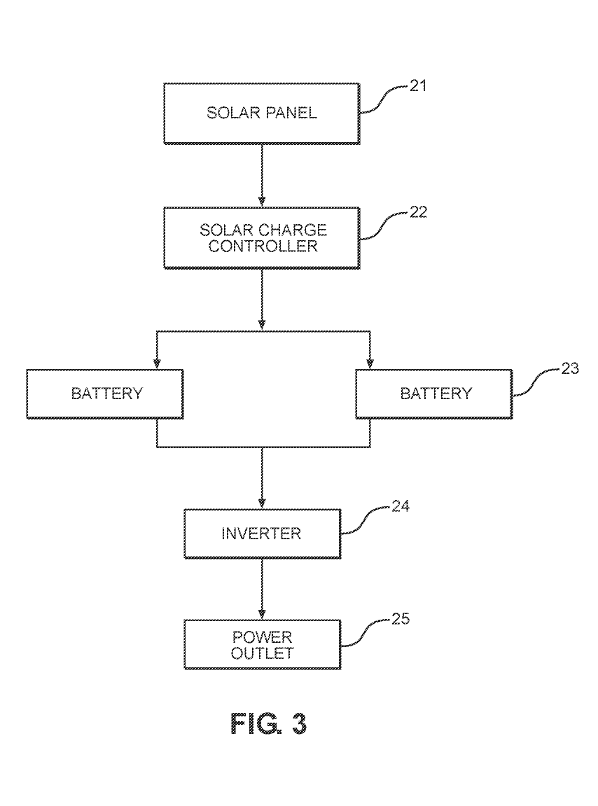

Referring now to FIG. 3, there is shown a flowchart of the operation of the portable solar power generator. One or more solar panels 21 are used to convert solar energy to electrical energy. Any of various types of solar panels 21 may be used having any of various DC power output ratings depending upon the amount of electricity desired to be produced. In order to produce more electricity, additional solar panels 21 can be connected in series to one another via electrical cables.

The one or more solar panels 21 are electrically connected to a solar charge controller 22, wherein the solar charge controller 22 is electrically connected to one or more rechargeable batteries 23. The solar charge controller 22 is adapted to regulate voltage and/or current in order to prevent the one or more batteries 23 from overheating. The batteries 23 will overcharge if they are provided with electricity that is a higher voltage than the battery 23 is configured to receive. The solar charge controller 22 is adapted to provide electricity to the batteries 23 at a suitable voltage and current for the specific battery 23 used. The rechargeable batteries 23 are then charged throughout the day as the solar panels 21 generate electricity.

The batteries 23 are electrically connected to an electrical inverter 24 that is adapted to convert direct current supplied by the batteries 23 to alternating current that can be used to power any of various electronic devices, appliances, and the like. The electrical inverter 24 is electrically connected to a power outlet 25 that is adapted to receive a power cable of an electronic device. In this way, the user is able to connect an electronic device to the power outlet 25 in order to charge or power the electronic device in the conventional manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable solar power generator, comprising:
a housing have a base, upstanding sidewalls, and an open upper end, defining an interior volume;
one or more solar panels are pivotally secured to the housing such that an angle of the one or more solar panels relative to a horizontal plane is adjustable;
one or more rechargeable batteries positioned within the interior volume of the housing and adapted to receive and store electricity generated by the one or more solar panels;
a power outlet electrically connected to the one or more rechargeable batteries adapted to distribute stored electricity.

2) The portable solar power generator of claim 1, wherein the housing comprises a pair of wheels on the base thereof.

3) The portable solar power generator of claim 1, wherein the housing comprises a fastener adapted to engage with the one or more solar panels so as to removably secure the one or more solar panels thereon.

4) The portable solar power generator of claim 3, wherein the one or more solar panels each include a mounting fastener on a rear surface thereof that is adapted to removably engage with the fastener on the housing.

5) The portable solar power generator of claim 1, further comprising a solar charge controller electrically connected to the one or more solar panels, wherein the solar charge controller is adapted to regulate the voltage of the electricity supplied to the one or more batteries.

6) The portable solar power generator of claim 1, further comprising an inverter electrically connected to the one or more batteries and to the power outlet, wherein the inverter is adapted to convert direct current generated by the one or more solar panels to alternating current.

7) The portable solar power generator of claim 1, wherein the one or more solar panels each include one or more securement straps thereon, wherein the securement straps are configured to be removably secured to a portion of the housing so as to secure the one or more solar panels to the housing at a desired angle.

8) The portable solar power generator of claim 1, wherein the housing further comprises a shelf therein, wherein the shelf is elevated above the base of the housing, and wherein the one or more batteries are positioned on the shelf.

9) The portable solar power generator of claim 1, wherein the power outlet is disposed on an exterior surface of the housing.

10) A portable solar power generator, comprising:
a housing have a base, upstanding sidewalls, and an open upper end, defining an interior volume, wherein the base comprises a pair of wheels thereon;
a lid pivotally secured to the open upper end, wherein the lid is movable between an opened and a closed configuration;
one or more solar panels are pivotally secured to the housing such that an angle of the one or more solar panels relative to a horizontal plane is adjustable;
a solar charge controller electrically connected to the one or more solar panels;
one or more rechargeable batteries electrically connected to the solar charge controller;
an inverter electrically connected to the one or more rechargeable batteries;
a power outlet electrically connected to the inverter, wherein the power outlet is adapted to distribute electricity stored within the one or more rechargeable batteries.
